(19) United States
(12) Patent Application Publication
(10) Pub. No.: US 2004/0250892 A1
(43) Pub. Date: Dec. 16, 2004

(54) Workpiece motion guide and method

(75) Inventor: Norston Fontaine, Minneapolis, MN (US)

Correspondence Address: CROMPTON, SEAGER & TUFTE, LLC, 1221 NICOLLET AVENUE, SUITE 800, MINNEAPOLIS, MN, 55403-2420, US

(73) Assignee: Bench Dog, Inc.

(21) Appl. No.: 10/788,865

(22) Filed: Feb. 27, 2004

Related U.S. Application Data
(63) Continuation of application No. 10/093,074, filed on Mar. 6, 2002, now abandoned.
Application No. 10/093,074 is a continuation of application No. 09/496,500, filed on Feb. 2, 2000, now abandoned.

(51) Int. Cl. B23H 1/00

(52) U.S. Cl. 144/144.1

(57) ABSTRACT

A motion guide for use with a machine having a table is disclosed. A motion guide in accordance with the present invention includes a body portion defining a top surface and a bottom surface, a first guiding surface extending between the top surface and the bottom surface, a second guiding surface extending between the top surface and the bottom surface, the second guiding surface being disposed at an angle relative to the first guiding surface, a plurality of keeper fingers protruding from a keeper surface extending between the top surface and the bottom surface, and disposed between the first guiding surface and the second guiding surface, the keeper fingers being generally parallel to each other, and an alignment member protruding from the keeper surface.

### FIELD OF THE INVENTION

The present invention relates generally to machines and tools for cutting and shaping wood. More particularly, the present invention relates to device which may be utilized to guide the motion of a wooden workpiece past a rotating cutter.

### BACKGROUND OF THE INVENTION

Many woodworking methods such as routing, joining and cutting involve the step of moving a workpiece past a rotating cutting tool. These operations are typically performed on a woodworking machine having a table. Examples of such machines include routertables, shapers, joiners, jointers, and table saws. Examples of rotating cutting tools include saw blades and router bits.

When performing a woodworking operation on a table such as routing, joining and cutting the machine operator must control the path of the workpiece as it moves relative to the cutting tool. The motion of the workpiece is typically guided in whole ore in part by hand. In some cases a motion guide may be utilized to aid the machine operator in guiding the motion of the workpiece. Examples of motion guides include fences, and featherboards.

A fence is typically an elongate metallic member which is fixed to the table of a machine. The fence typically includes an elongate, flat guiding surface which is oriented at a ninety degree angle to the top surface of the table. A workpiece may be held by the hands of the machine operator against the guiding surface of the fence as the workpiece is moved past the cutting tool.

A stop controls the movement of the workpiece by blocking its path. A stop may be used to position a plurality of workpieces in the same longitudinal position so that consistency can be achieved. This is particularly useful for repetitive operations, such as when several pieces of wood must be cut to equivalent length for cabinetry.

A feather board is a motion guide which may be utilized to prevent an occurrence known in the art as kickback. Kickback occurs when the workpiece binds to a cutting tool, for example the blade of a table saw. As a workpiece is cut on a table saw, the blade removes material from the workpiece creating an elongate kerf through the workpiece. Residual stresses within the workpiece sometimes cause the material of the workpiece to close around the blade. A portion of the workpiece may bind to the blade, causing the workpiece to be carried along with the blade as it rotates at high speed. When kickback occurs, the workpiece is thrown upwardly and rearwardly toward the body of the saw operator. The workpiece may strike the unfortunate operator causing bodily injury.

A feather board may include a plurality of pawls. The pawls are typically biased so that they ride over a surface of the workpiece as it is fed in a forward direction past the cutting tool. When a kickback situation arises, the workpiece begins movement in a reverse direction causing a corresponding rotation of the pawls. As the pawls rotate, they may jam the workpiece against a fence mounted on the table of the machine, thereby preventing any further reverse movement.

### SUMMARY OF THE INVENTION

The present invention relates generally to machines and tools for cutting and shaping wood. More particularly, the present invention relates to device which may be utilized to guide the motion of a wooden workpiece past a rotating cutter. One embodiment of a motion guide in accordance with the present invention includes a body portion defining a top surface and a bottom surface and a first guiding surface extending between the top surface and the bottom surface. The motion guide further includes a second guiding surface extending between the top surface and the bottom surface, wherein the second guiding surface is generally disposed at an acute angle relative to the first guiding surface. In a presently preferred embodiment, the motion guide includes a plurality of keeper fingers protruding from a keeper surface extending between the top surface and the bottom surface.

A motion guide in accordance with the present invention may be utilized to prevent kickback when a machine operator is performing an operation on a workpiece. The motion guide may be positioned so that the fingers of the motion guide are biased so that they ride over a surface of the workpiece as it is fed in a forward direction past the cutting tool. When a kickback situation arises, the workpiece begins movement in a reverse direction causing a corresponding rotation of the fingers. As the fingers rotate, they may jam the workpiece against a surface of the machine thereby preventing any further reverse movement.

In a presently preferred method, an alignment finger of the motion guide is utilized to position the motion guide such that the keeper fingers will have a desirable bias. This solves the problem of assuring that the motion guide is located the correct distance away from the workpiece. If the motion guide is mounted too far away from the workpiece, insufficient tension will be applied to the piece. If the motion guide is mounted too close to the workpiece, the machine operator will have to push harder against the workpiece. A step of locating the motion guide may include the steps of positioning the alignment finger on the surface of the workpiece, and fixing the motion guide in that location with appropriate fasteners.

A motion guide in accordance with the present invention may also be utilized to provide a fulcrum point when performing an operation on a workpiece. The motion guide may be positioned such that a corner or a curved surface of the motion guide is disposed in a desirable location for use as a fulcrum. An motion guide in accordance present invention may be place in any number of positions. A portion of the workpiece may be seated against the corner of the motion guide. In a presently preferred method the machine operator may use his hand(s) to apply forces to a proximal end of the workpiece causing a distal portion of the workpiece to contact a cutting tool while a middle portion of the workpiece rests against the corner of the motion guide. In this manner, the workpiece may be pivoted against the corner of the motion guide allowing the machine operator to obtain a mechanical advantage and to keep his or her hands a desirable distance away from the cutting tool.

A motion guide in accordance with the present invention may also be utilized to provide a motion stop when performing an operation on a workpiece. This motion stop allows the machine operator to make repeated operations with equivalent results on different workpieces. For example, FIG. 16 illustrates a router table having a router bit and a fence. A first motion guide and a second motion guide are fixed to the fence. A workpiece may be positioned so that it is seated against the fence. The workpiece may be moved relative to the router bit until a first end of the workpiece contacts the first motion guide. The workpiece may also be moved relative to the router bit until a second end of the workpiece contacts a second end of the motion guide.

A motion guide in accordance with the present invention may be utilized to provide a motion stop when performing an operation on a workpiece. This motion stop allows the machine operator to make repeated operations with equivalent results on different workpieces. For example, a first motion guide and a second motion guide may be fixed to a fence. A workpiece may be positioned so that it is seated against the fence. The workpiece may be moved relative to a router bit proximate the fence until a first end of the workpiece contacts the first motion guide. The workpiece may also be moved relative to the router bit until a second end of the workpiece contacts a second end of the motion guide.

A motion guide in accordance with the present invention may be utilized to provide a guiding surface when performing an operation on a workpiece. The guiding surface may aid a machine operator in moving the workpiece in a substantially straight line path. For example, a motion guide having a guiding surface may be fixed to a table of a routertable. A workpiece may seated against the guiding surface of the motion guide. The workpiece may be urged longitudinally along the guiding surface of the motion guide while a portion of the workpiece contacts a router bit of the routertable.

### BRIEF DESCRIPTION OF THE DRAWINGS

FIG. 1 is a perspective view of a motion guide in accordance with the present invention;

FIG. 2 is a plan view of the motion guide of FIG. 1;

FIG. 3 is a cross sectional view of the motion guide of FIG. 1 and FIG. 2;

FIG. 4 is a perspective view of a motion guide in accordance with the present invention selectively fixed to a table of a table saw in accordance with one method of the present invention;

FIG. 5 is a plan view of a slide in accordance with the present invention;

FIG. 6 is a cross sectional view of an assembly in accordance with the present invention;

FIG. 7 is a plan view of a motion guide in accordance with the present invention selectively fixed to a work surface of a routertable in accordance with one method of the present invention;

FIG. 8 is a plan view of a slide in accordance with the present invention;

FIG. 9 is a cross sectional view of an assembly in accordance with the present invention;

FIG. 10 is a cross sectional view of an assembly in accordance with the present invention;

FIG. 11 is a perspective view of a track in accordance with the present invention fixed to a work table;

FIG. 12 is a plan view of a slide in accordance with the present invention;

FIG. 13 is a cross sectional view of an assembly in accordance with the present invention including the track of FIG. 11 and the slide of FIG. 12;

FIG. 14 is a plan view of a motion guide in accordance with the present invention;

FIG. 15 is a plan view illustrating a motion guide in accordance with the present invention fixed to a fence of a table saw in accordance with a method of the present invention;

FIG. 16 is a plan view illustrating a plurality of motion guides fixed to a routertable in accordance with a method of the present invention;

FIG. 17 is a plan view illustrating a plurality of motion guides fixed to a routertable in accordance with a method of the present invention; and

FIG. 18 is a plan view of a routertable including a work table, and a motion guide fixed to the work table of the router table.

### DETAILED DESCRIPTION OF THE INVENTION

The following detailed description should be read with reference to the drawings, in which like elements in different drawings are numbered identically. The drawings which are not necessarily to scale, depict selected embodiments and are not intended to limit the scope of the invention. Examples of constructions, materials, dimensions, and manufacturing processes are provided for selected elements. Those skilled in the art will recognize that many of the examples provided have suitable alternatives which may be utilized.

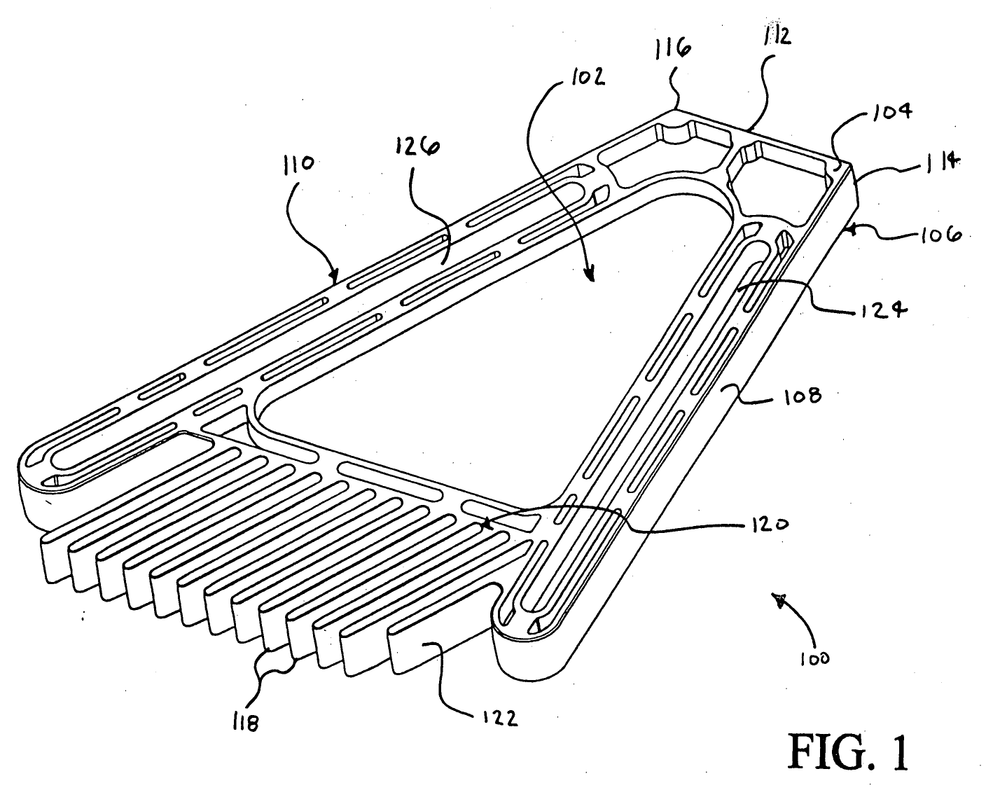

FIG. 1 is a perspective view of a motion guide 100 in accordance with the present invention. Motion guide 100 includes a body portion 102 defining a top surface 104 and a bottom surface 106. A first guiding surface 108 extends between top surface 104 and bottom surface 106. Motion guide 100 also includes a second guiding surface 110 extending between top surface 104 and bottom surface 106. In the embodiment of FIG. 1, second guiding surface 110 is disposed at an acute angle relative to first guiding surface 108. In a presently preferred embodiment, the angle between first guiding surface 108 and second guiding surface 110 is between about 10 degrees and about 80 degrees. In a presently more preferred embodiment, the angle between first guiding surface 108 and second guiding surface 110 is about 35 degrees. Those of skill in the art will appreciate that second guiding surface 110 may be disposed at any angle relative to first guiding surface 108 without departing from the spirit and scope of the present invention. For example, second guiding surface 110 may be substantially parallel to first guiding surface 108.

Motion guide 100 includes a third guiding surface 112 extending between top surface 104 and bottom surface 106. A first corner 114 is formed where third guiding surface 112 meets first guiding surface 108. A second corner 116 is formed where third guiding surface 112 meets second guiding surface 110.

Motion guide 100 includes a plurality of keeper fingers 118 which protrude from a keeper surface 120 extending between top surface 104 and bottom surface 106. An alignment finger 122 also protrudes from keeper surface 120. In a presently preferred embodiment, alignment finger 122 is generally shorter than keeper fingers 118.

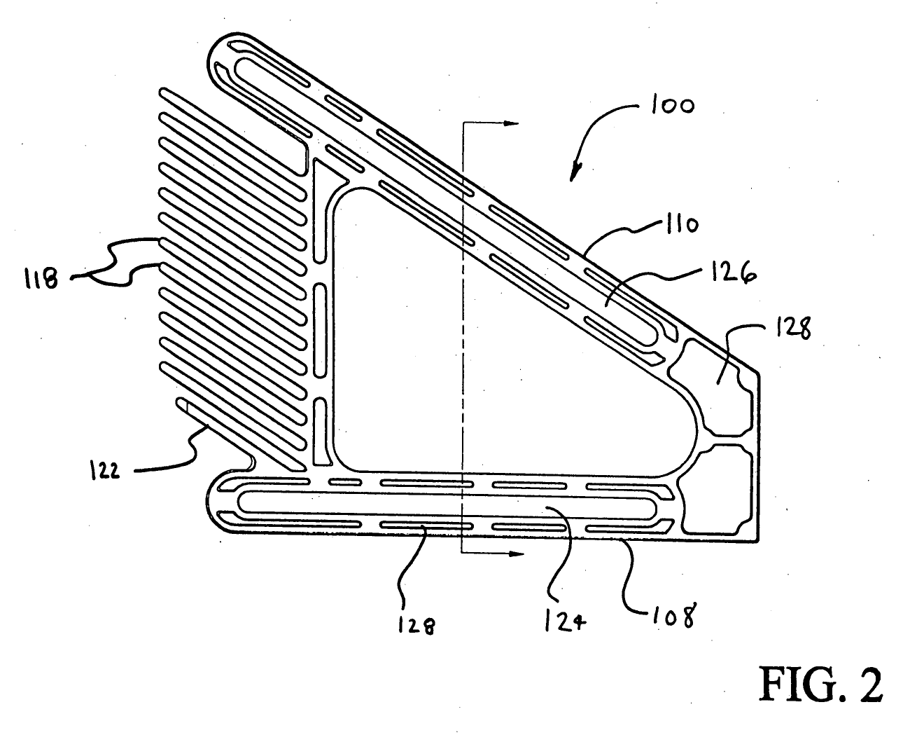

FIG. 2 is a plan view of motion guide 100 of FIG. 1. As shown in FIG. 2, body portion 102 of motion guide 100 defines a first slot 124 and a second slot 126. In the embodiment of FIG. 2, first slot 124 is generally parallel to first guiding surface 108. Likewise, second slot 126 is generally parallel to second guiding surface 110.

In FIG. 2, it may be appreciated that keeper fingers 118 are generally parallel to each other. In a presently preferred embodiment, keeper fingers 118 are substantially flexible. In the embodiment of FIG. 2, body portion 102 of motion guide 100 defines a plurality of cores 128.

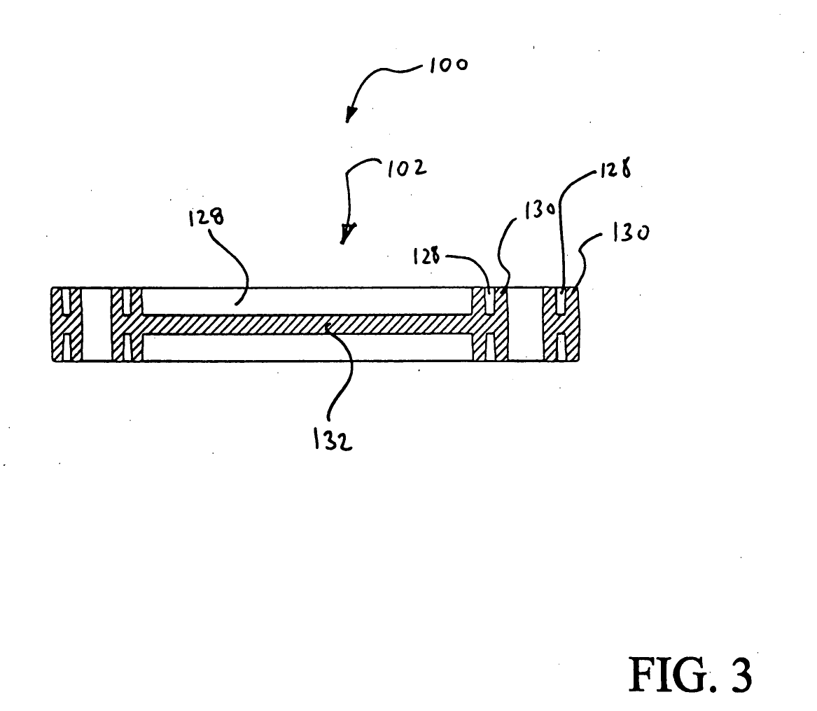

FIG. 3 is a cross sectional view of motion guide 100. In FIG. 3, it may be appreciated that body portion 102 of motion guide 100 includes a plurality of vertical walls 130 and a plurality of horizontal walls 132 defining cores 128. In the embodiment of FIG. 3, the size and position of cores 128 have been selected so that the thickness of vertical walls 130 is more or less uniform.

In a presently preferred embodiment, motion guide 100 of FIG. 3 is fabricated utilizing an injection molding process. Those of skill in the art will appreciate that other methods of fabricating motion guide 100 are possible without deviating from the spirit and scope of the present invention. Examples of manufacturing processes which may be suitable in some applications include machining, die casting, and investment casting. Motion guide 100 may be comprised of any number of metallic or non-metallic materials. Examples of metallic materials which may be suitable in some applications include aluminum and zinc. Examples of thermoplastic materials which may be suitable in some applications include: polyethylene (PE), polypropylene (PP), polyvinylchloride (PVC), polyurethane, polytetrafluoroethylene (PTFE), polyamide, polyimide, and polycarbonate.

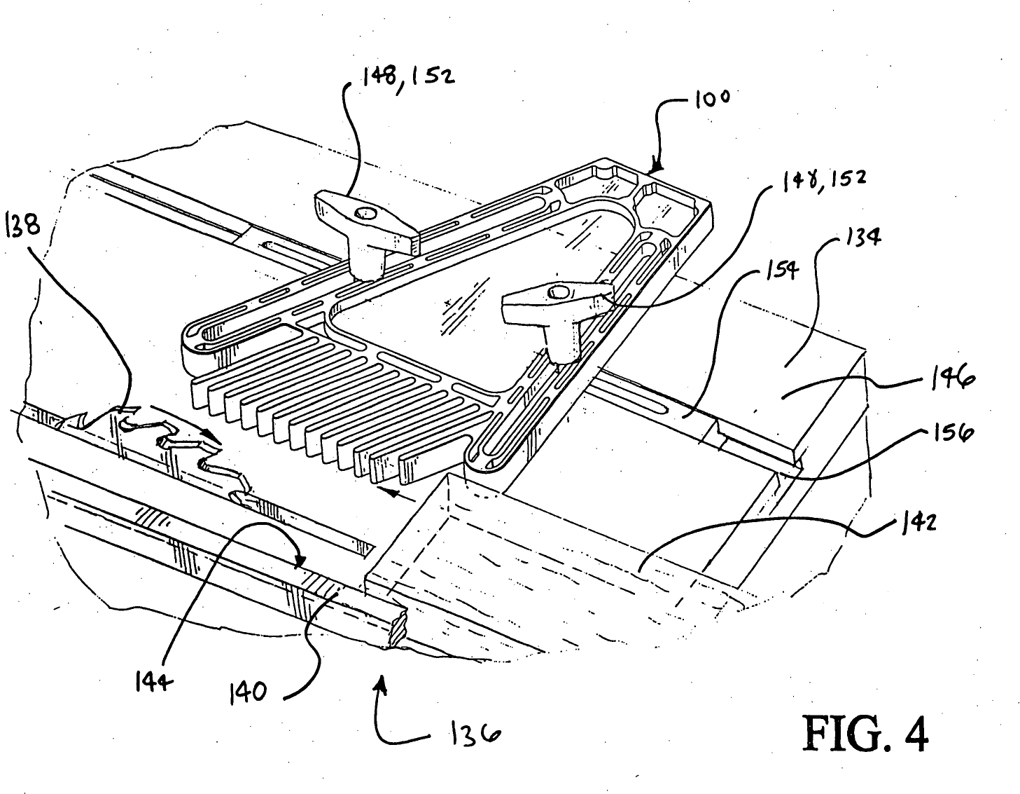

FIG. 4 is a perspective view of a motion guide 100 selectively fixed to a table 134 of a table saw 136. Table saw 136 of FIG. 4 includes a cutting tool 138 and a fence 140. A workpiece 142 is seated against a fence surface 144 of fence 140 and a table surface 146 of table 134. Motion guide 100 is selectively fixed to table 134 of table saw 136 with fasteners 148 each including tee handle 152 and a T-slide 154. T-slide 154 is disposed within a T-slot 156 defined by table 134 of table saw 136.

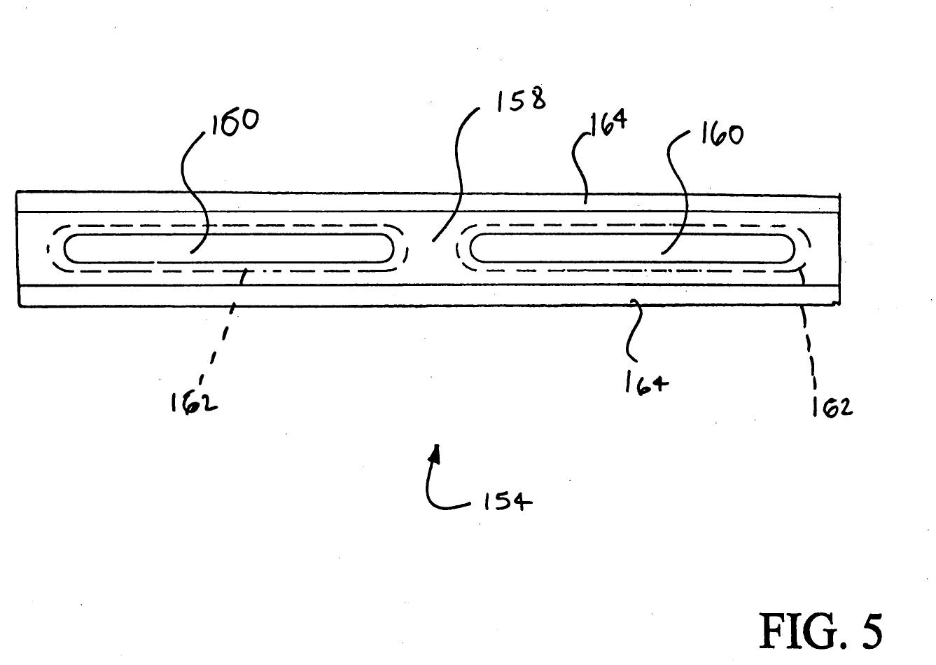

FIG. 5 is a plan view of a T-slide 154 in accordance with the present invention. In the embodiment of FIG. 5, T-slide 154 includes a T-slide body 158 defining a plurality of slots 160 and a plurality of recesses 162. T-slide 154 of FIG. 5 also includes two toes 164.

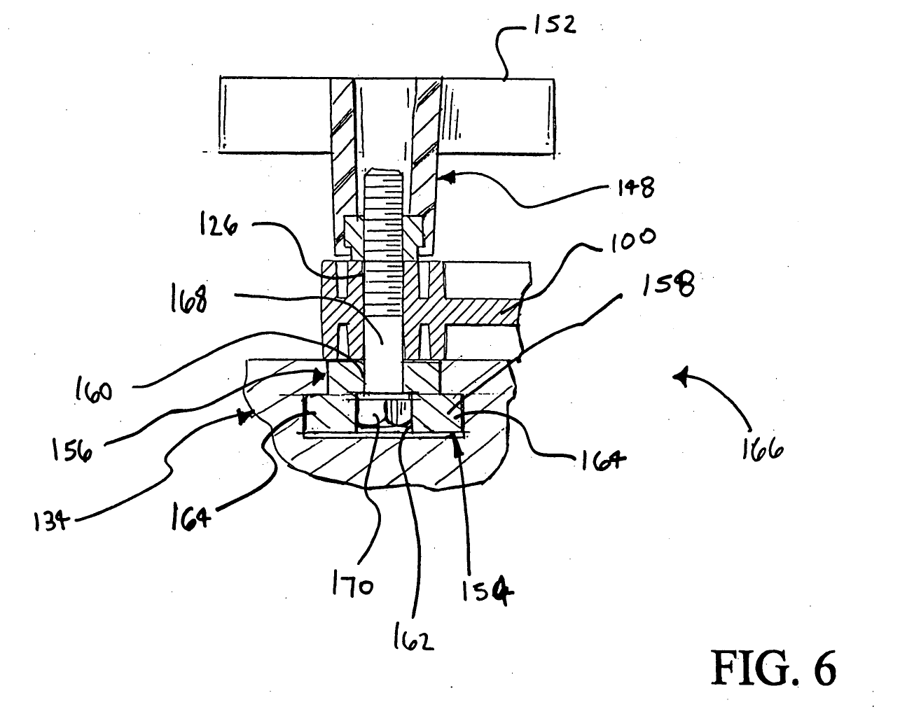

FIG. 6 is a cross sectional view of an assembly 166 including a T-slide 154. As in the previous embodiment, T-slide 154 includes a T-slide body 158 and a plurality of toes 164. Assembly 166 also includes a bolt 168 including a head 170. In the embodiment of FIG. 6, the shape of head 170 of bolt 168 may be generally described as a hexagonal projection. Those of skill in the art will appreciate that other shapes of head 170 are possible without deviating from the spirit and scope of the present invention. In the embodiment of FIG. 6, head 170 of bolt 168 is disposed within a recess 162 of T-slide 154. Bolt 168 extends through a slot 160 of T-slide 154 and a slot 126 of a motion guide 100. A fastener 148 having a tee handle 152 is fixed to bolt 168 proximate a distal end thereof. T-slide 154 is disposed within a T-slot 156 of a table 134.

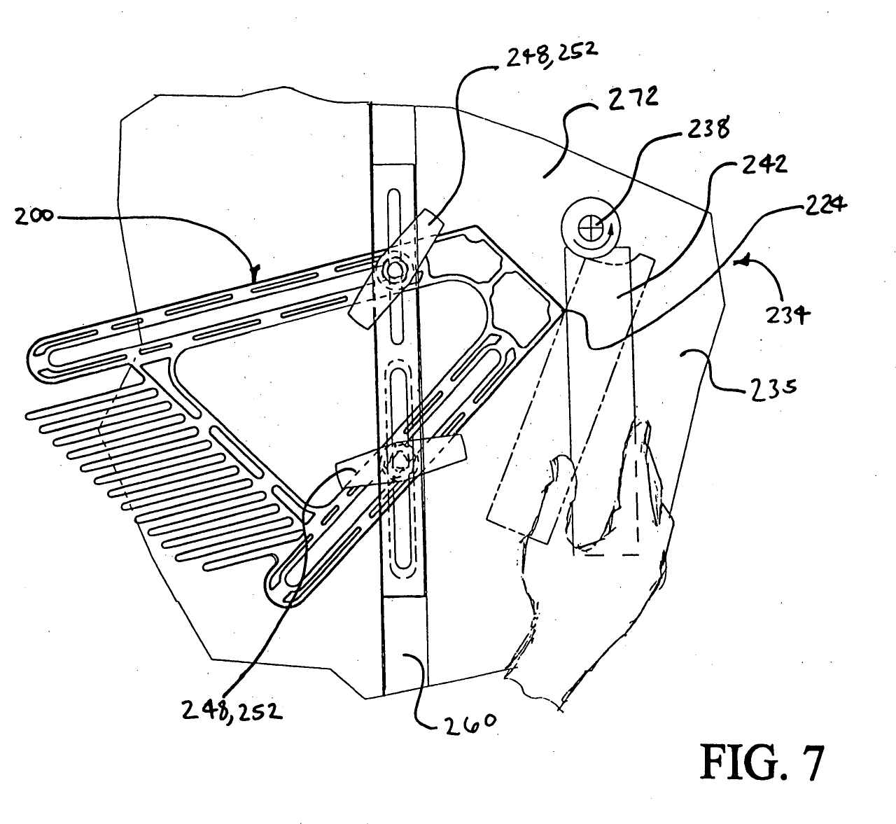

FIG. 7 is a plan view of a motion guide 200 disposed on a work surface 272 defined by a routertable 234. Routertable 234 of FIG. 7 also includes a router bit 238 and a table 235 defining a slot 260. Motion guide 200 is selectively fixed to table 235 of routertable 234 with fasteners 248 each including a tee handle 252 and a slide 274. Slide 274 is disposed within slot 260 defined by table 235 of routertable 234. A workpiece 242 is seated against a first corner 224 of motion guide 200 and work surface 272 of routertable 234. A hand of a machine operator is disposed about a portion of workpiece 242.

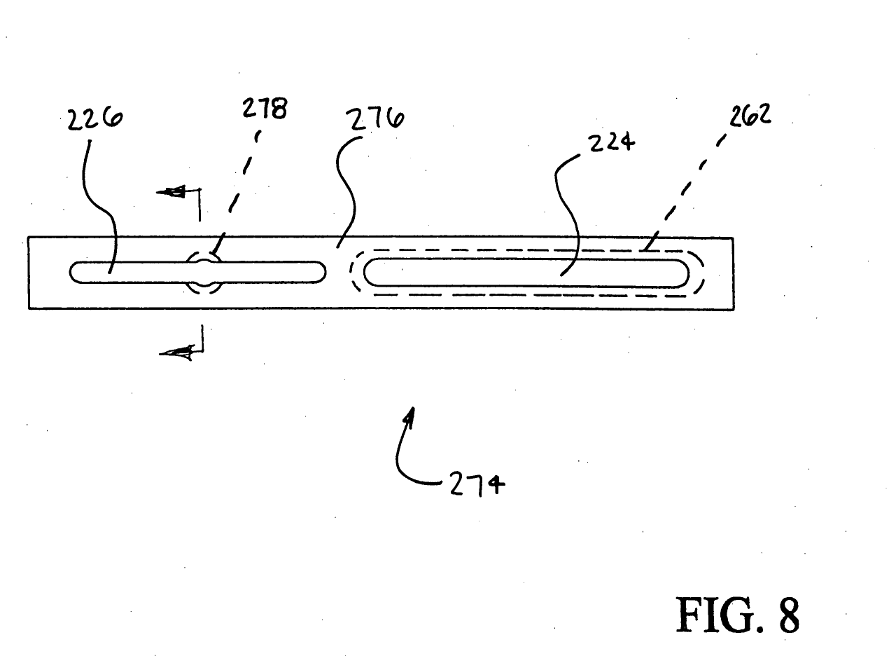

FIG. 8 is a plan view of a slide 274 in accordance with the present invention. In the embodiment of FIG. 8, slide 274 includes a slide body 276 defining a first slot 224 and a second slot 226. A generally conical cavity 278 is defined by slide body 276 proximate first slot 224 and a recess 262 is defined by slide body 276 proximate second slot 226.

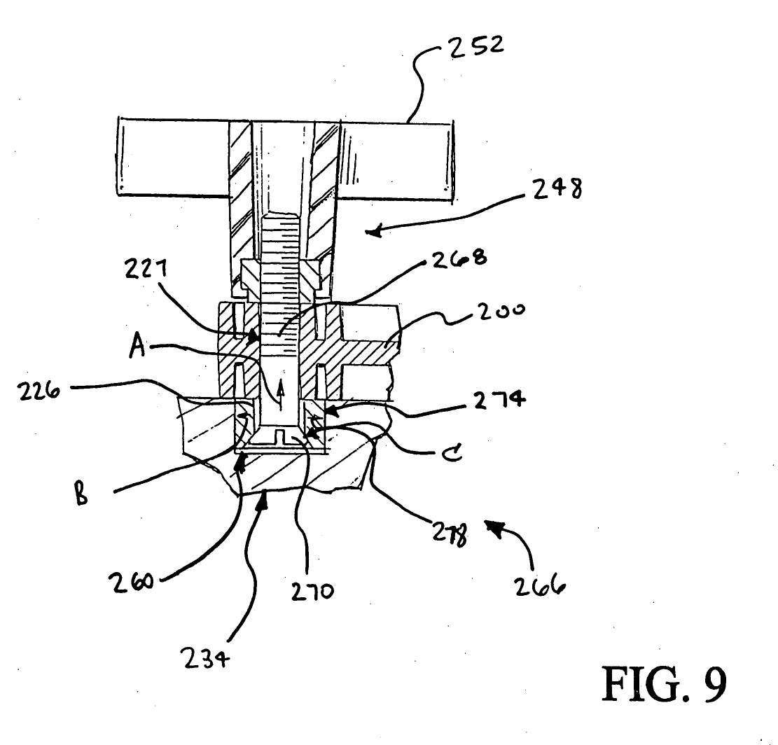

FIG. 9 is a cross sectional view of an assembly 266 including a slide 274 and a bolt 268. Bolt 268 includes a generally conical head 270 adapted to be disposed within generally conical cavity 278 of slide 274. Bolt 268 extends through slot 226 of slide 274 and a slot 227 of motion guide 200. A fastener 248 having a tee handle 252 is fixed to bolt 268 proximate a distal end thereof. Slide 274 is disposed within a slot 260 of a table 235. In a presently preferred embodiment bolt 268 is urged in the direction indicated by arrow A by fastener 248. In this presently preferred embodiment, conical head 270 of bolt 268 causes deflection of slide 274 in the directions indicated by arrow B and arrow C of FIG. 9. The deflection of slide 274 may create a friction fit between slide 274 and slot 260 of table 235 of routertable 234.

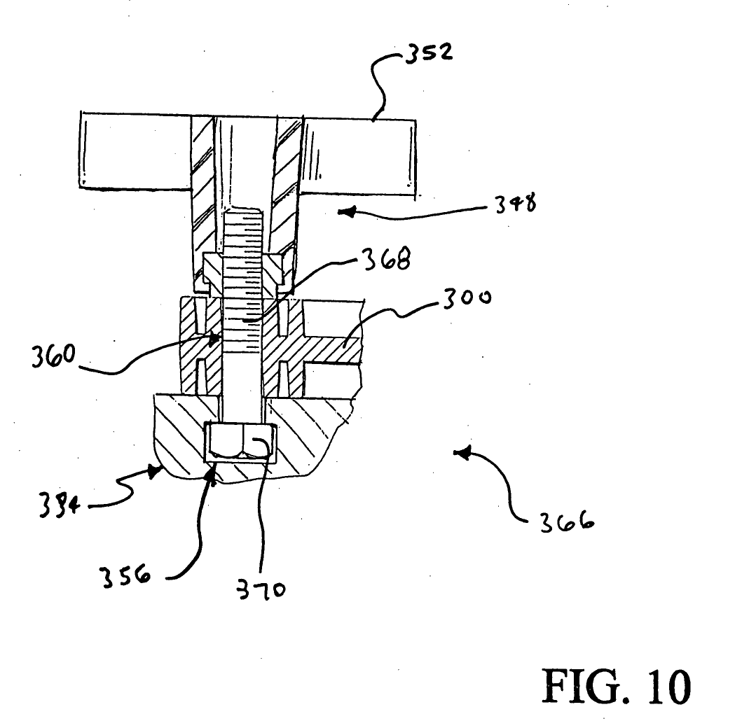

FIG. 10 is a cross sectional view of an assembly 366 including a motion guide 300 and a bolt 368 having a head 370. In the embodiment of FIG. 10, the shape of head 370 of bolt 368 may be generally described as a hexagonal projection. Those of skill in the art will appreciate that other shapes of head 370 are possible without deviating from the spirit and scope of the present invention. Head 370 of bolt 368 is disposed within a T-slot 356 defined by a table 334. Bolt 368 extends beyond T-slot 356 and extends though a slot 360 of motion guide 300. A fastener 348 having a tee handle 352 is fixed to bolt 368 proximate a distal end thereof. In a presently preferred embodiment the presence of head 370 of bolt 368 within T-slot 356 of table 334 prevents bolt 368 from rotating.

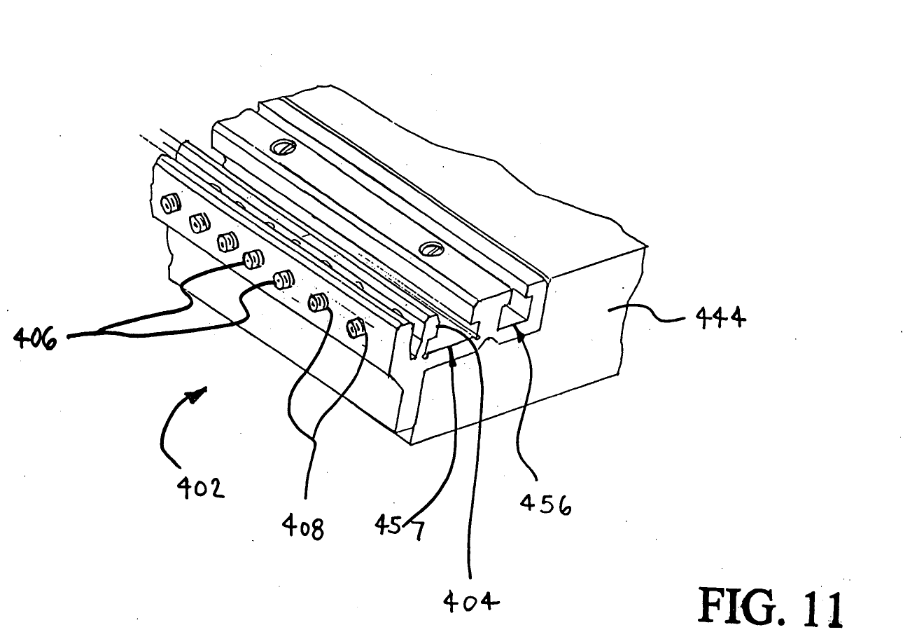

FIG. 11 is a perspective view of a track 402 fixed to a work table 444. Track 402 includes a first T-slot 456 and a second T-slot 457 having an outer wall 404. Track 402 further includes a plurality of threaded holes 408. A plurality of set screws 406 are disposed in threaded holes 408. In a presently preferred embodiment, set screws 406 may be utilized to deflect outer wall 404 of second T-slot 457.

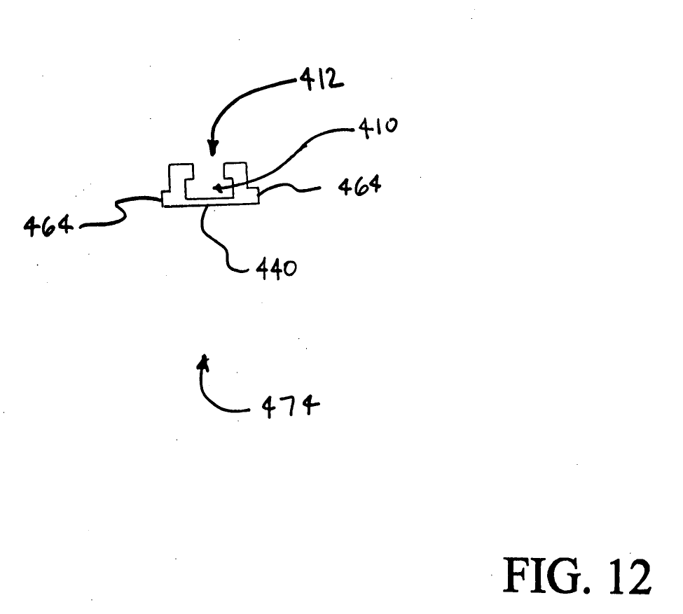

FIG. 12 is a plan view of a slide 474 in accordance with the present invention. In the embodiment of FIG. 12, slide 474 includes a body member 440, and two toes 464. Body member 440 defines a cavity 410 and a slot 412. A motion guide may be fixed to slide 474 utilizing a fastener. A head portion of the fastener may be disposed within cavity 410 and a shaft portion of the fastener may extend through slot 412. In a presently preferred embodiment, slide 474 is fabricated utilizing an extrusion process. Those of skill in the art will appreciate that other manufacturing methods may be utilized without deviating from the spirit or scope of the present invention.

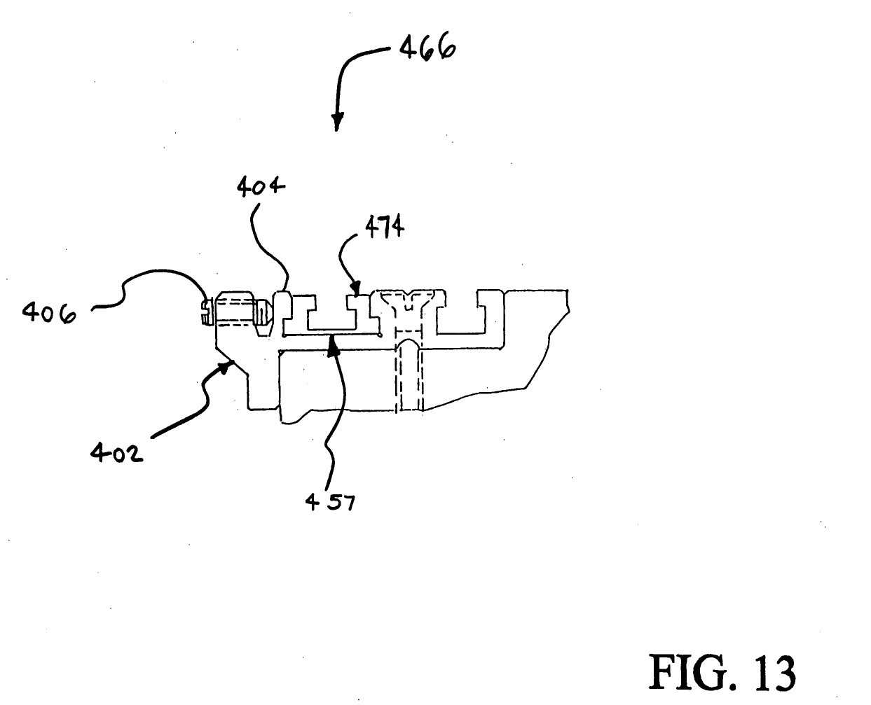

FIG. 13 is a cross sectional view of an assembly 466 including track 402 of FIG. 13 and T-slide 454 of FIG. 12. In the embodiment of FIG. 13, T-slide 474 is disposed within second T-slot 457 of track 402. In a presently preferred embodiment, set screws 406 may be utilized to deflect outer wall 404 of second T-slot 457. Also in a presently preferred embodiment, the position of slide 474 may be fixed by pinching it within T-slot 456.

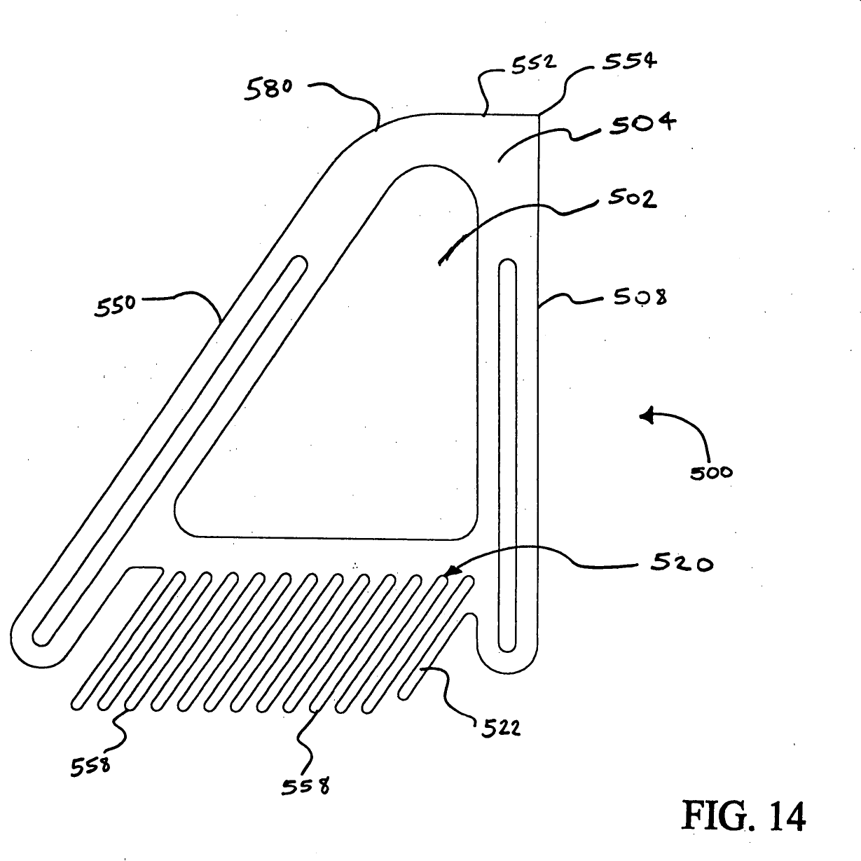

FIG. 14 is a plan view of a motion guide 500 in accordance with the present invention. Motion guide 500 includes a body portion 502 defining a top surface 504 and a bottom surface 506 (not shown). A first guiding surface 508 extends between top surface 504 and bottom surface 506. Motion guide 500 also includes a second guiding surface 550 extending between top surface 504 and bottom surface 506. In the embodiment of FIG. 5, second guiding surface 550 is disposed at an acute angle relative to first guiding surface 508. In a presently preferred embodiment, the angle between first guiding surface 508 and second guiding surface 550 is between about 10 degrees and about 80 degrees. In a presently more preferred embodiment, the angle between first guiding surface 508 and second guiding surface 550 is about 35 degrees. Those of skill in the art will appreciate that second guiding surface 550 may be disposed at any angle relative to first guiding surface 508 without departing from the spirit and scope of the present invention. For example, second guiding surface 550 may be substantially parallel to first guiding surface 508.

Motion guide 500 also includes a third guiding surface 552 and a curved guiding surface 580. Third guiding surface 552 extends between top surface 504 and bottom surface 506. Curved guiding surface 580 is disposed between third guiding surface 552 and second guiding surface 550. A first corner 554 is formed where third guiding surface 552 meets first guiding surface 508.

Motion guide 500 includes a plurality of keeper fingers 558 which protrude from a keeper surface 520 which extends between top surface 504 and bottom surface 506. An alignment finger 522 also protrudes from keeper surface 520. In a presently preferred embodiment, alignment finger 522 is generally shorter than keeper fingers 558.

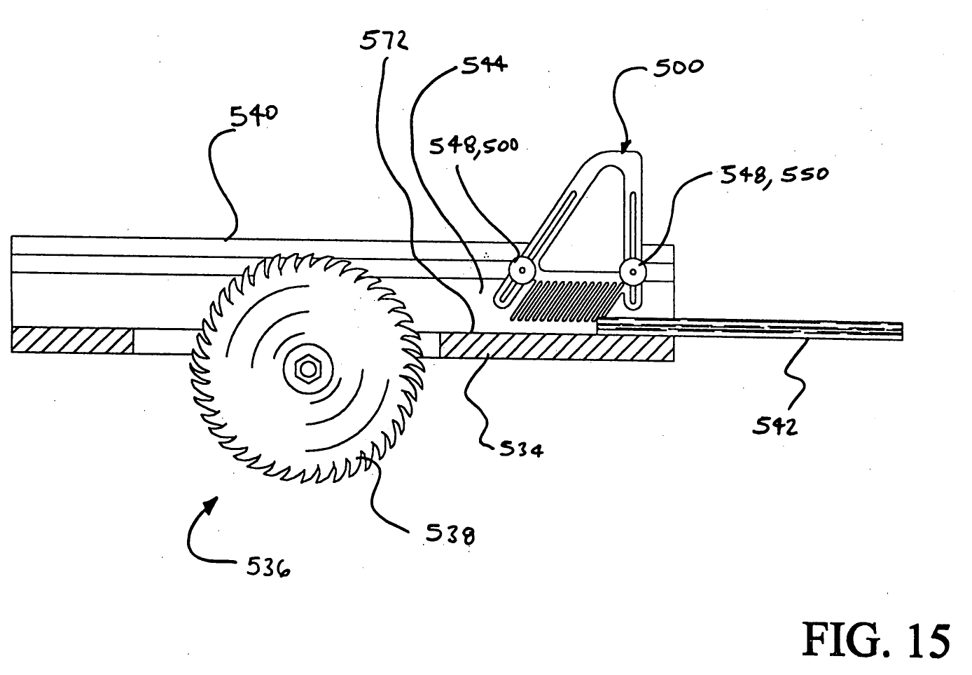

FIG. 15 is a plan view of a table saw 536 including a work table 534, a cutting tool 538 and a fence 540. A motion guide 500 is fixed to fence 540 by a plurality of fasteners 548 each including a round knob 550. A workpiece 542 is seated against a work surface 572 defined by work table 534 and a fence surface 544 defined by fence 540.

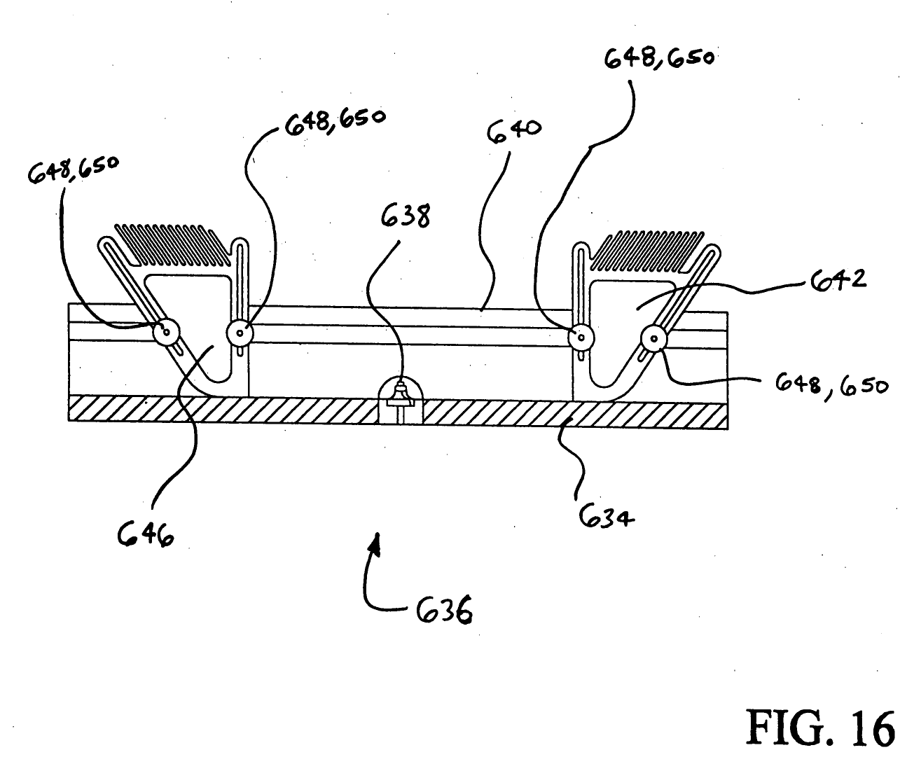

FIG. 16 is a plan view of a routertable 636 including a work table 634, a router bit 638, and a fence 640. A first motion guide 646 is fixed to fence 640 by a plurality of fasteners 648 each including a round knob 650. Likewise, a second motion guide 642 is fixed to fence 640 by a plurality of fasteners 648 each including a round knob 650.

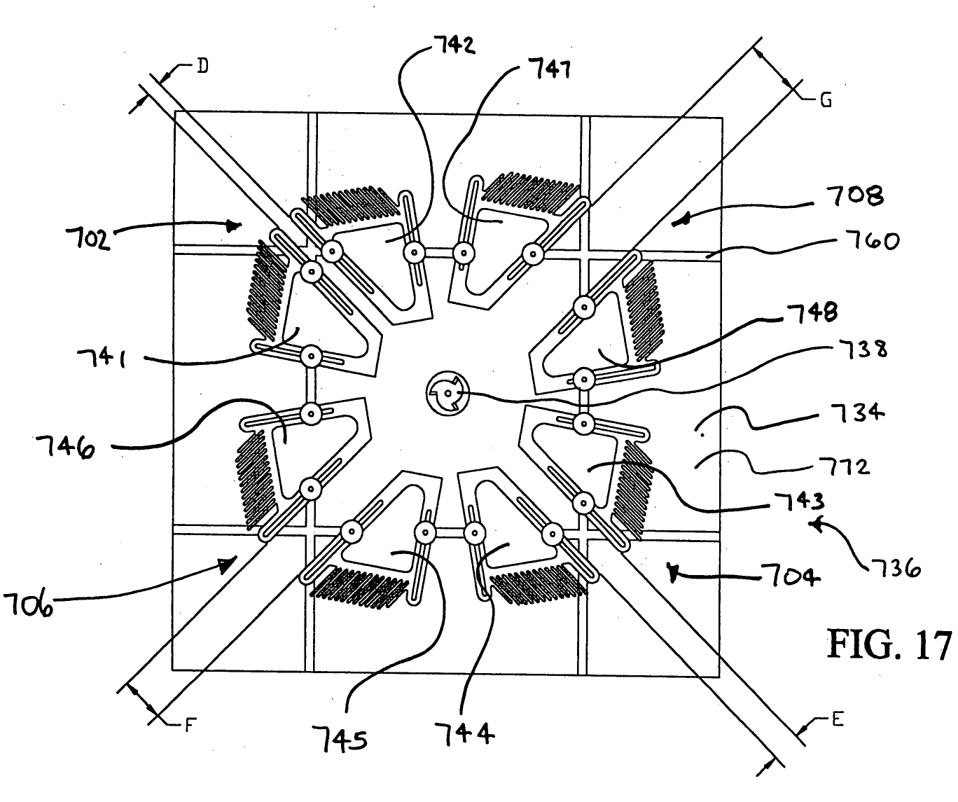

FIG. 17 is a plan view of a routertable 736 including a router bit 738 and a work table 734 defining a plurality of mounting slots 760. In the embodiment of FIG. 17 router bit 738 is a type which may be generally referred to as a slotting cutter.

A first setup 702 is disposed on a work surface 772 defined by work table 734. First setup 702 includes a first motion guide 747 and a second motion guide 742. In the embodiment of FIG. 17, first motion guide 747 and second motion guide 742 are arranged so that a guiding surface of first motion guide 747 is generally parallel to a guiding surface of second motion guide 742. The distance between the guiding surface of first motion guide 747 and the guiding surface of second motion guide 742 is indicated by the letter “D” in FIG. 17. In a presently preferred embodiment, first setup 702 is adapted for use with workpieces having a width corresponding to width “D” of FIG. 17.

A second setup 704 is disposed on a work surface 772 defined by work table 734. Third setup 706 includes a third motion guide 743 and a fourth motion guide 744. In the embodiment of FIG. 17, third motion guide 743 and fourth motion guide 744 are arranged so that a guiding surface of third motion guide 743 is generally parallel to a guiding surface of fourth motion guide 744. The distance between the guiding surface of third motion guide 743 and the guiding surface of fourth motion guide 744 is indicated by the letter “E” in FIG. 17. In a presently preferred embodiment, second setup 704 is adapted for use with workpieces having a width corresponding to width “E” of FIG. 17.

A third setup 706 is disposed on a work surface 772 defined by work table 734. Third setup 706 includes a fifth motion guide 745 and a sixth motion guide 746. In the embodiment of FIG. 17, fifth motion guide 745 and sixth motion guide 746 are arranged so that a guiding surface of fifth motion guide 745 is generally parallel to a guiding surface of sixth motion guide 746. The distance between the guiding surface of fifth motion guide 745 and the guiding surface of sixth motion guide 746 is indicated by the letter “F” in FIG. 17. In a presently preferred embodiment, third setup 706 is adapted for use with workpieces having a width corresponding to width “F” of FIG. 17.

A fourth setup 708 is disposed on a work surface 772 defined by work table 734. Fourth setup 708 includes a seventh motion guide 747 and a eighth motion guide 748. In the embodiment of FIG. 17, seventh motion guide 747 and eighth motion guide 748 are arranged so that a guiding surface of seventh motion guide 747 is generally parallel to a guiding surface of eighth motion guide 748. The distance between the guiding surface of seventh motion guide 747 and the guiding surface of eighth motion guide. 748 is indicated by the letter “G” in FIG. 17. In a presently preferred embodiment, fourth setup 708 is adapted for use with workpieces having a width corresponding to width “G”of FIG. 17. Referring to FIG. 17 it may be appreciated that router table 734 may be utilized to cut slots into workpieces having differing widths without making a special setup, or altering any of the existing setups.

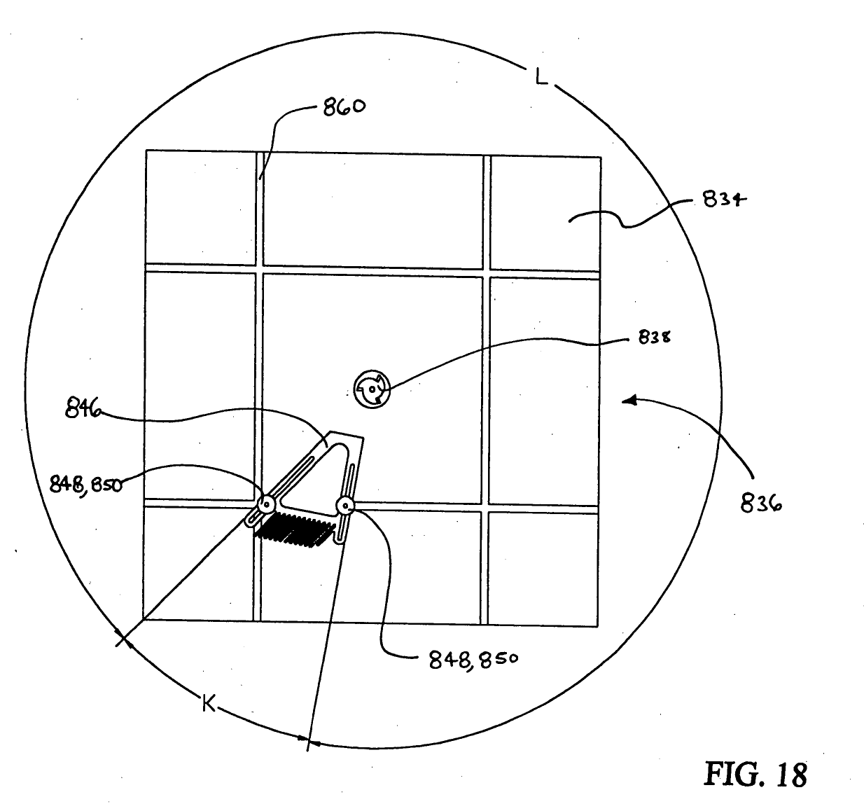

FIG. 18 is a plan view of a routertable 836 including a router bit 838 and a work table 834 defining a plurality of mounting slots 860. A motion guide 846 is fixed to work table 834 by a plurality of fasteners 848 each including a round knob 850. A first angle K and a second angle L are indicated in FIG. 18.

Having thus described the figures, methods in accordance with the present invention may now be described with reference thereto. It should be understood that steps may be omitted from each process and/or the order of the steps may be changed without deviating from the spirit or scope of the invention. It is anticipated that in some applications, two or more steps may be performed essentially simultaneously to promote efficiency.

A method in accordance with the present invention may begin with the step of fixing a motion guide to a portion of a machine, for example, a work table and/or a fence. The step of fixing a motion guide to a fence may include the step of inserting one or more bolts through an aperture in a slide, and through an aperture in the motion guide. The distal end of the bolt may also be inserted into a fastener, for example a Tee-nut. The bolt may be tightened so that it fixes the slide to the motion guide.

In one method in accordance with the present invention, an assembly including a motion guide and a slide may be retained for use on a future job. In this method, the time required for setting up a job is reduced because the machine operator does not need to position the motion guide relative to the slide.

A method in accordance with the present invention may include the step of inserting a slide into a slot defined by a machine portion. Examples of machine portions include work tables and fences. The slide may be fixed in a desirable location within the slot. A number of methods may be used to fix the slide within the slot. For example, the slot may include a threaded hole, threaded fastener may be threaded into the threaded hole so that it exerts a force onto the bottom of the slot. By way of a second example, the slide may include a conical cavity adapted to receive the conical head of a bolt; when the bolt is tightened, it may urge the sides of the slide outward, creating a friction fit between the slide and the slot.

A motion guide in accordance with the present invention may be utilized to prevent kickback when a machine operator is performing an operation on a workpiece. For example, FIG. 4 and FIG. 15 depict cutting operations utilizing a motion guide to prevent kickback. The motion guide may be positioned so that the fingers of the motion guide are biased so that they ride over a surface of the workpiece as it is fed in a forward direction past the cutting tool. When a kickback situation arises, the workpiece begins movement in a reverse direction causing a corresponding rotation of the fingers. As the fingers rotate, they may jam the workpiece against a surface of the machine thereby preventing any further reverse movement.

In a presently preferred method, an alignment finger of the motion guide is utilized to position the motion guide such that the keeper fingers will have a desirable bias. This solves the problem of assuring that the motion guide is located the correct distance away from the workpiece. If the motion guide is mounted too far away from the workpiece, insufficient tension will be applied to the piece. If the motion guide is mounted too close to the workpiece, the machine operator will have to push harder against the workpiece. A step of locating the motion guide may include the steps of positioning the alignment finger on the surface of the workpiece, and fixing the motion guide in that location with appropriate fasteners.

A motion guide in accordance with ‘the present invention’ may be utilized to provide a fulcrum point when performing an operation on a workpiece. For example, FIG. 7 illustrates the use of a motion guide to provide a fulcrum during a routing operation. The motion guide may be positioned such that a corner of the motion guide is disposed in a desirable location for use as a fulcrum. A motion guide in accordance present invention may be place in any number of positions. A portion of the workpiece may be seated against the corner of the motion guide. In a presently preferred method the machine operator may use his hand(s) to apply forces to a proximal end of the workpiece causing a distal portion of the workpiece to contact a cutting tool while a middle portion of the workpiece rests against the corner of the motion guide. In this manner, the workpiece may be pivoted against the corner of the motion guide allowing the machine operator to obtain a mechanical advantage and to keep his or her hands a desirable distance away from the cutting tool.

A machine operator may also utilized a curved guiding surface of a motion guide as a fulcrum. For example, FIG. 14 illustrates a motion guide having a curved guiding surface and a corner. A machine operator may choose between the curved guiding surface and the corner by selectively mounding the motion guide. For example, the motion guide can be flipped over. Embodiments of the motion guide have also been envisioned which include first curved guiding surface having a first radius and a second curved guiding surface having a second radius. When the first radius is different from the second radiuses, the machine operator will have two different curved guiding surfaces to choose from.

A motion guide in accordance with the present invention may be utilized to provide a motion stop when performing an operation on a workpiece. This motion stop allows the machine operator to may make repeated operations with equivalent results on different workpieces. For example, FIG. 16 illustrates a router table having a router bit and a fence. A first motion guide and a second motion guide are fixed to the fence. A workpiece may be positioned so that it is seated against the fence. The workpiece may be moved relative to the router bit until a first end of the workpiece contacts the first motion guide. The workpiece may also be moved relative to the router bit until a second end of the workpiece contacts a second end of the motion guide.

A motion guide in accordance with the present invention may be utilized to provide a guiding surface when performing an operation on a workpiece. The guiding surface may aid a machine operator in moving the workpiece in a substantially straight line path. For example, FIG. 16 illustrates a router table having a slotting cutter and four setups adapted to accept boards of different widths. A slot may be cut into a distal portion of a workpiece and urging the workpiece along a guiding surface until the distal end of the workpiece contacts the slotting cutter. The routertable illustrated in FIG. 17 may be utilized to cut slots into workpieces having differing widths without making a special setup, or altering any of the existing setups.

Having thus described the preferred embodiments of the present invention, those of skill in the art will readily appreciate that yet other embodiments may be made and used within the scope of the claims hereto attached. For example, embodiments have been envisioned in which the motion guide includes a plurality of indices disposed on surface thereof, wherein the indices may be utilized to measure the length of a workpiece.

Numerous advantages of the invention covered by this document have been set forth in the foregoing description. It will be understood, however, that this disclosure is, in many respects, only illustrative. Changes may be made in details, particularly in matters of shape, size, and arrangement of parts without exceeding the scope of the invention. The inventions's scope is, of course, defined in the language in which the appended claims are expressed.

1. A motion guide for use with a machine having a table, comprising:
a body portion defining a top surface and a bottom surface;
a first side extending between the top surface and the bottom surface;
a second side extending between the top surface and the bottom surface; and
the second side being disposed an angle relative to the first side.

2.-20. (Cancelled)
